(19) United States
(12) Patent Application Publication
(10) Pub. No.: US 2025/0060497 A1
(43) Pub. Date: Feb. 20, 2025

(54) Using Uncontrolled Acoustic Energy in Combination with Controlled Seismic Source Energy to Retrieve Information About a Subsurface

(71) Applicant: PGS Geophysical AS, Oslo (NO)

(72) Inventor: Stian Hegna, Oslo (NO)

(73) Assignee: PGS Geophysical AS, Oslo (NO)

(21) Appl. No.: 18/806,957

(22) Filed: Aug. 16, 2024

Related U.S. Application Data
(60) Provisional application No. 63/533,507, filed on Aug. 18, 2023.

(51) Int. Cl. G01V 1/34; G01V 1/137; G01V 1/157; G01V 1/30; G01V 1/38

(52) U.S. Cl. CPC G01V 1/345; G01V 1/137; G01V 1/157; G01V 1/303; G01V 1/3843

(57) ABSTRACT

One or more images of subsurface geological features are generated based on recorded seismic data that contain controlled source components and uncontrolled source components blended together. A current recorded dataset is determined from the recorded seismic data, and one or more iterations of a separation procedure are performed on the current recorded dataset to accumulate isolated controlled source components and isolated uncontrolled source components therefrom. The one or more images are generated based on the isolated controlled source components and on the isolated uncontrolled source components.

### CROSS-REFERENCE TO RELATED APPLICATIONS

This application claims benefit to the filing date of U.S. Provisional Patent Application No. 63/533,507, filed on 2023 Aug. 18 (the “Provisional Application”), the contents of which are hereby incorporated by reference as if entirely set forth herein. In the event of conflict between the meaning of a term used in this document and the same or a similar term used in the Provisional Application or in another document incorporated herein by reference, the meaning associated with this document shall control.

### BACKGROUND

Marine seismic surveys are performed in large bodies of water to gain information about geological features that are disposed beneath the water bottom. Such surveys are performed for a variety of purposes. Some, for example, are performed to identify locations of hydrocarbon reservoirs or to determine changes in properties of such reservoirs. Others are performed to assess the suitability of a site for the installation of structures such as wind turbines, pipelines, or cables. Still others are performed to inspect existing installations.

In most marine seismic surveys, actively controlled seismic sources are used to produce acoustic energy that propagates through the water into the subsurface. Some of the energy produced by the sources is reflected from the subsurface and is recorded by geophysical sensors. The recorded reflections may then be used in a process known as “imaging” to produce a visual or numeric representation of the geological features that produced the reflections.

Actively-controlled seismic sources are controlled by one or more seismic source controllers located onboard a survey vessel. They typically include one or more impulsive sources, one or more non-impulsive sources, or a combination of impulsive and non-impulsive sources. Impulsive sources produce a sharp pressure impulse in the water responsive to a control pulse generated by a seismic source controller. Non-impulsive sources, on the other hand, are not driven by a brief control pulse and do not produce a sharp pressure impulse in the water. Rather, non-impulsive sources are driven by a sweep control signal (also generated by a seismic source controller) that varies over a period of time to produce a series of pressure wave vibrations in the water. The pressure wave vibrations so produced typically follow a pattern that sweeps through a range of frequencies as determined by the sweep control signal.

Examples of impulsive sources include air guns, sparkers, and boomers. An air gun source uses compressed air to produce a pressure impulse in the water when the source is activated by an activation pulse. Sparker sources and boomer sources also produce a pressure impulse in the water responsive to an activation pulse, but they do so by different mechanisms. In the case of a sparker source, the activation pulse causes multiple sparks to be generated simultaneously between respective spark gaps disposed in the water. The sparks produce transient vapor bubbles, which in turn produce a pressure impulse in the water. In the case of a boomer source, which resembles an audio loudspeaker, the activation pulse causes a diaphragm in the source to move abruptly. For boomer sources, it is the movement of the diaphragm that produces the pressure impulse in the water.

An example of a non-impulsive source is a marine vibrator, which produces pressure wave vibrations in the water that correspond to the time-varying frequencies in a sweep control signal.

Any marine seismic source that operates responsive to a control or activation pulse generated by a seismic source controller, or to a sweep control signal generated by a seismic source controller, may be referred to herein as a “controlled seismic source,” a “controlled source,” an “active seismic source,” or simply an “active source.”

Controlled seismic sources have traditionally been preferred for use in marine seismic surveys because of the predictable acoustic energy wavefields they produce. The predictable nature of controlled seismic source energy has utility during the process of imaging, during which a known source signal may be deconvolved from recorded reflections to isolate an earth response produced by features in the subsurface. The predictable nature of controlled seismic source energy also enables efficiencies to be gained during data acquisition through techniques known as simultaneous shooting and deblending. In simultaneous shooting, multiple controlled seismic sources are activated closely in time with one another during a single marine seismic survey such that reflected energy attributable to several different controlled source activations overlaps in time and is thus recorded together in a blended fashion. One or more deblending techniques are then applied to the blended recordings in order to separate reflected energy attributable to one of the controlled sources from reflected energy that is attributable to others of the controlled sources. It is the predictable nature of the controlled source energy that enables such deblending techniques to be successful.

It is also possible to use uncontrolled acoustic energy (for example, ambient acoustic energy) in certain contexts to gain information about a subsurface. Hereinafter, the phrase “uncontrolled acoustic energy” will refer to acoustic energy that is present in a body of water but that is not produced by a controlled seismic source and thus is not controlled by a seismic source controller. Examples of uncontrolled acoustic energy include particle motion generated by a vessel as it sails over or near a survey site, and particle motion generated by stationary machinery such as a wind turbine or drilling platform disposed in the vicinity of a survey site. Other sources of uncontrolled acoustic energy are also possible in marine environments. The terms “uncontrolled acoustic source,” “uncontrolled source,” and the like as used herein refer to any such source of acoustic energy that is present in a marine environment but that is not generated by controlled seismic sources. Acoustic energy that is produced by uncontrolled sources tends to be less predictable in its characteristics than acoustic energy that is produced by controlled seismic sources.

### BRIEF DESCRIPTION OF THE DRAWINGS

FIGS. 1 and 2 are top and side views, respectively, illustrating an example towed streamer marine seismic survey in accordance with embodiments.

FIGS. 3-5 are block diagrams schematically illustrating example groupings of seismic sensors in accordance with embodiments.

FIG. 6 is a diagram illustrating several types of offsets in marine seismic surveys.

FIG. 7 is a side view illustrating a further example towed streamer marine seismic survey in accordance with embodiments.

FIG. 8 is a side view illustrating an example ocean bottom cable marine seismic survey in accordance with embodiments.

FIG. 9 is a side view illustrating an example ocean bottom node marine seismic survey in accordance with embodiments.

FIG. 10 is a flow diagram illustrating a process in accordance with embodiments for isolating controlled source components and uncontrolled source components from recorded seismic data and for generating one or more images of subsurface features based on the isolated controlled source components and on the isolated uncontrolled source components.

FIG. 11 is a flow diagram illustrating an iterative separation procedure in accordance with embodiments.

FIG. 12 is a flow diagram illustrating a single iteration of the separation procedure of FIG. 11 in more detail.

FIG. 13 is a flow diagram illustrating a general technique in accordance with embodiments for determining the contribution of a source wavefield to a recorded seismic dataset.

FIGS. 14-15 are flow diagrams illustrating techniques according to embodiments for determining impulsive source components in a recorded seismic dataset.

FIG. 16 is a flow diagram illustrating a technique according to embodiments for determining uncontrolled source components in a recorded seismic dataset.

FIG. 17 is a flow diagram illustrating a technique according to embodiments for determining an earth response to uncontrolled acoustic sources.

FIG. 18 is a block diagram illustrating an example computing device that may be used to implement methods according to embodiments.

### DETAILED DESCRIPTION

This disclosure describes multiple embodiments by way of example and illustration. It is intended that characteristics and features of all described embodiments may be combined in any manner consistent with the teachings, suggestions, and objectives contained herein. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others. The phrase “configured to” as used herein means that the referenced item, when operated, can perform the described function. In this sense, an item can be “configured to” perform a function even when the item is not operating and therefore is not currently performing the function. Use of the phrase “configured to” herein does not necessarily mean that the described item has been modified in some way relative to a previous state. “Coupled” as used herein refers to a connection between items. Such a connection can be direct, or can be indirect, such as through connections with other intermediate items. Terms used herein such as “including,” “comprising,” and their variants, mean “including but not limited to.” Articles of speech such as “a,” “an,” and “the” as used herein are intended to serve as singular as well as plural references except where the context clearly indicates otherwise.

### Marine Seismic Surveys Generally

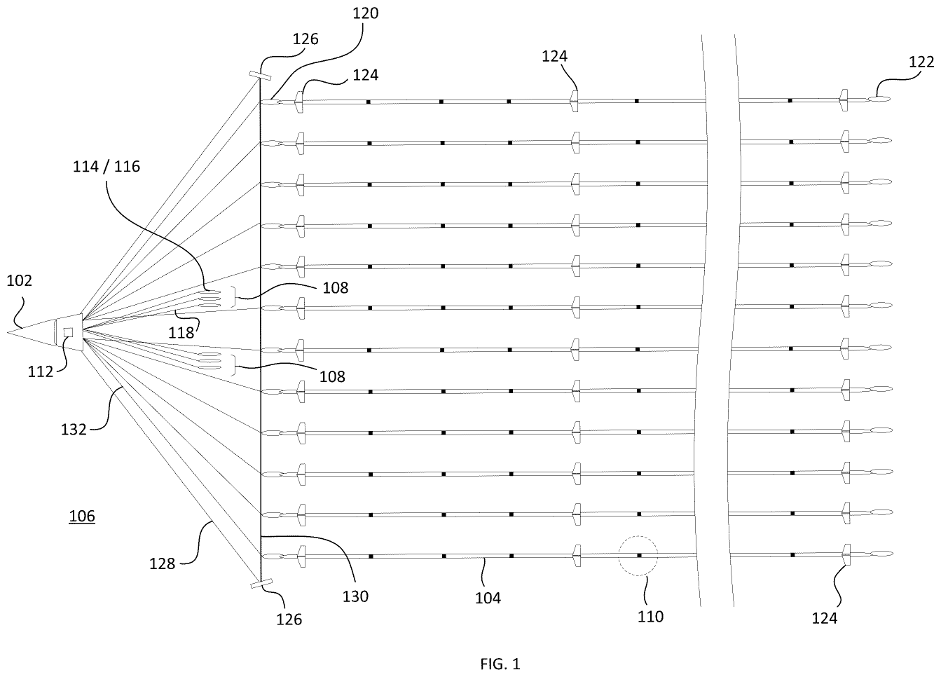

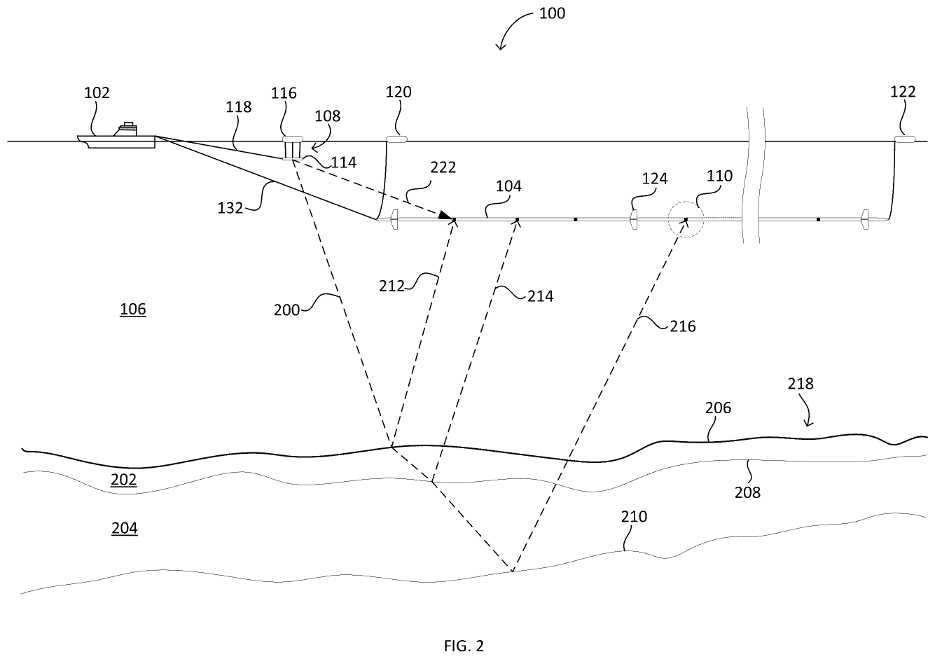

FIGS. 1 and 2 present top and side elevation views, respectively, of an example towed-streamer marine seismic survey system that employs controlled seismic sources. Survey system 100 is representative of a variety of similar geophysical survey systems in which a vessel 102 tows an array of elongate sensor streamers 104 in a body of water 106 such as an ocean, a sea, a bay, or a large lake. Typically the vessel is equipped with at least one global positioning system (“GPS”) unit so that its location during the survey may be known and recorded for later use. Vessel 102 is shown towing twelve streamers 104 in the illustrated example. In other embodiments, any number of streamers may be towed, from as few as one streamer to as many as twenty or more. The terms “streamer” and “cable” as used herein should be interpreted to include any type of seismic sensor cable, and the two terms may be used interchangeably below.

During a typical marine seismic survey, one or more controlled seismic sources 108 are activated to produce acoustic energy 200 that propagates in body of water 106. Energy 200 penetrates various layers of sediment and rock 202, 204 underlying body of water 106. As it does so, it encounters interfaces 206, 208, 210 between materials having different physical characteristics, including different acoustic impedances. At each such interface, a portion of energy 200 is reflected upward while another portion of the energy is refracted downward and continues toward the next lower interface, as shown. Reflected energy 212, 214, 216 is detected by sensors 110 disposed at intervals along the lengths of streamers 104, along with a so-called direct wavefield that reaches the sensors via a path, such as path 222, that travels directly from the controlled sources 108 to the location of the sensors. In FIGS. 1 and 2, sensors 110 are indicated as black squares inside each of streamers 104. Sensors 110 produce signals corresponding to the reflected energy. These signals are collected and recorded by control equipment 112 located onboard vessel 102. The recorded signals may be processed and analyzed onboard vessel 102 and/or at one or more onshore data centers to produce images of structures within subsurface 218. These images can be useful, for example, in identifying possible locations of hydrocarbon reservoirs within subsurface 218 or in assessing the suitability of sites for the installation of offshore structures.

Any number of controlled sources 108 may be used in a marine seismic survey. In the illustrated example, vessel 102 is shown towing two such sources. In other systems, different numbers of sources may be used, and the sources may be towed by other vessels, which vessels may or may not tow additional streamer arrays. Typically, a controlled source 108 includes one or more source subarrays 114, and each subarray 114 includes one or more acoustic emitters such as air guns, sparkers, boomers, or marine vibrators. Each subarray 114 may be suspended at a desired depth from a subarray float 116. Compressed air and/or electrical power and control signals may be communicated to each subarray via source umbilical cables 118. Data may be collected, also via source umbilical cables 118, from various sensors located on subarrays 114 and/or floats 116, such as acoustic transceivers and GPS units. Acoustic transceivers and GPS units so disposed help to accurately determine the positions of each subarray 114 during a survey.

In some marine seismic surveys, streamers 104 are very long—on the order of 5 to 10 kilometers—so are constructed by coupling numerous shorter streamer sections together. In other marine seismic surveys, such as those used to assess sites for the installation of offshore structures, the streamers may be relatively short—on the order of 100 meters in length, for example.

In any such surveys, each streamer 104 may be attached to a dilt float 120 at its proximal end (the end nearest vessel 102) and to a tail buoy 122 at its distal end (the end farthest from vessel 102). Dilt floats 120 and tail buoys 122 may be equipped with GPS units as well to help determine the positions of each streamer 104 relative to an absolute frame of reference such as the earth. Each streamer 104 may in turn be equipped with acoustic transceivers and/or compass units to help determine their positions between GPS units and/or relative to one another. In many survey systems 100, streamers 104 include steering devices 124 attached at intervals, such as every 300 meters. Steering devices 124 typically provide one or more control surfaces to enable moving the streamer to a desired depth, or to a desired lateral position, or both. Paravanes 126 are shown coupled to vessel 102 via tow ropes 128. As the vessel tows the equipment, paravanes 126 provide opposing lateral forces that straighten a spreader rope 130, to which each of streamers 104 is attached at its proximal end. Spreader rope 130 helps to establish a desired crossline spacing between the proximal ends of the streamers. Power, control, and data communication pathways are housed within lead-in cables 132, which couple the sensors and control devices in each of streamers 104 to the control equipment 112 onboard vessel 102.

Collectively, the array of streamers 104 forms a sensor surface at which acoustic energy is received for recording by control equipment 112. In many instances, it is desirable for the streamers to be maintained in a straight and parallel configuration to provide a sensor surface that is generally flat, horizontal, and uniform. In other instances, an inclined and/or fan shaped receiving surface may be desired and may be implemented using control devices on the streamers such as those just described. Other array geometries may be implemented as well. Prevailing conditions in body of water 106 may cause the depths and lateral positions of streamers 104 to vary at times, of course. In various embodiments, streamers 104 need not all be the same length and need not all be towed at the same depth or with the same depth profile.

Sensors 110 within each streamer 104 may include one or more different sensor types such as pressure sensors (e.g., hydrophones) and/or motion sensors. Examples of motion sensors include velocity sensors (e.g., geophones) and acceleration sensors (e.g., accelerometers) such as micro-electromechanical system (“MEMS”) devices. In general, pressure sensors provide a magnitude-only, or scalar, measurement. This is because pressure is not associated with a direction and is therefore a scalar quantity. Motion sensors such as velocity sensors and acceleration sensors, however, each provide a vector measurement that includes both a magnitude and, at least implicitly, a direction, as velocity and acceleration are both vector quantities. Velocity sensors and acceleration sensors each may be referred to herein as “motion sensors.”

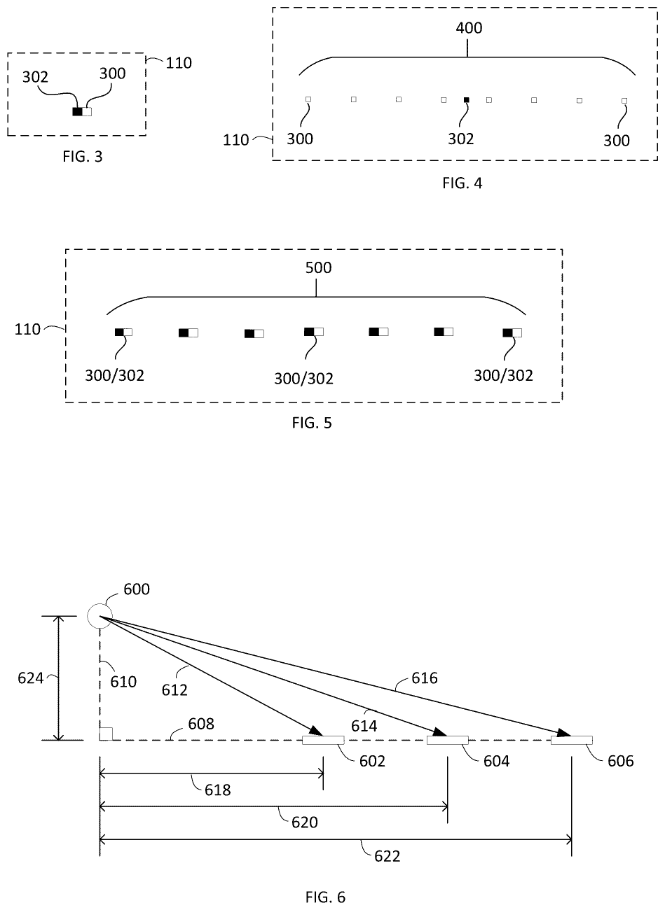

FIGS. 3, 4 and 5 illustrate several example arrangements consistent with embodiments for disposing sensors 110 in a streamer or cable 104 or in an ocean bottom node or an ocean bottom cable. In each illustration, pressure sensors are indicated with white squares, while motion sensors are indicated with shaded squares.

In the arrangement of FIG. 3, each sensor location 110 comprises a single pressure sensor 300 collocated with a single motion sensor 302. In the arrangement of FIG. 4, each sensor location 110 comprises a set of pressure sensors 300 forming a single pressure sensor group 400. A motion sensor 302 is disposed substantially at the center of pressure sensor group 400. (It is also possible to employ a similar arrangement in which a single pressure sensor is disposed among a group of motion sensors.) Typically, the signals generated by sensors forming a sensor group are combined or aggregated in some way, such as by summation and/or averaging. Such combination or aggregation may be accomplished in any suitable manner, such as in an analog domain using appropriate electrical coupling, or in a digital domain using digital data processing. In general, a sensor group may include any number of sensors and may comprise either pressure sensors or motion sensors. Normally, however, only measurements of the same type in a group (e.g., pressure, velocity, or acceleration) would be subject to combination or aggregation. Thus, in the particular arrangement illustrated in FIG. 4, the measurements of pressure sensors 300 may be combined or aggregated into a single signal, while the measurements of motion sensor 302 would be preserved as a separate signal. In the arrangement of FIG. 5, each sensor location 110 comprises a group 500 of collocated pressure sensors 300 and motion sensors 302. In the latter arrangement, one aggregated signal can be generated from the pressure sensors in the group, while another aggregated signal can be generated from the motion sensors in the group. Various other permutations of the arrangements of FIGS. 3, 4 and 5 are also possible. For example, any of these arrangements may comprise pressure sensors only or motion sensors only.

### Offsets in Marine Seismic Surveys

FIG. 6 is provided to illustrate the concept of offset in marine seismic surveys. In the figure, circle 600 represents a source, while each of rectangles 602, 604, 606 represents a sensor or sensor group. For example, sensors or sensor groups 602-606 may represent sensors disposed along the length of a single streamer 104, or may represent sensors in distinct ocean bottom nodes or sensors disposed within an ocean bottom cable. Dashed line 608 depicts an inline direction. Dashed line 610 depicts a crossline direction orthogonal to the inline direction. Typically, a vessel towing a source would follow a sail path parallel to inline direction 608.

The distance between a source and any one sensor or sensor group constitutes an offset. Such an offset may be measured from the source to a single sensor, or to any one of the sensors within a sensor group, or to the center of a sensor group. Three different example offsets are illustrated in the drawing, ranging in length from a smallest offset 612, to an intermediate length offset 614, to a largest offset 616. A distance along the straight line path between a source and a given sensor or sensor group, as depicted by arrows 612-616, is commonly referred to as a “seismic offset” or simply an “offset.” A distance along direction 608 between a source and the inline projection of a sensor or sensor group is commonly referred to as an “inline offset.” Thus, sensor or sensor group 602 defines a smallest inline offset 618 with respect to source 600, sensor or sensor group 604 defines an intermediate length inline offset 620 with respect to the source, and sensor or sensor group 606 defines a largest inline offset 622 with respect to the source. Similarly, a distance along direction 610 between a sensor or sensor group and the crossline projection of the source is commonly referred to as a “crossline offset.” In the illustrated example, each of sensors or sensor groups 602-606 defines the same crossline offset 624 with respect to source 600.

The term “offset” as used herein refers to any of the above-described distances.

### EXAMPLE EMBODIMENTS

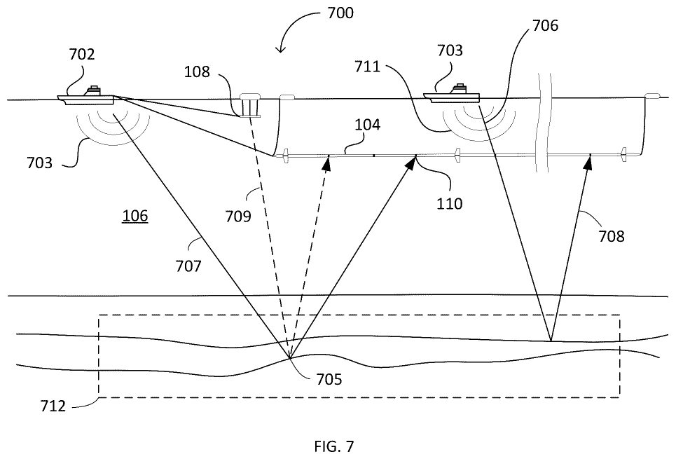

FIG. 7 is a side view illustrating an example marine seismic survey 700 in accordance with embodiments. In survey 700, a vessel 702 tows at least one controlled seismic source 108. The controlled seismic source(s) may include any one or more of the source types described above or others, including without limitation air gun sources, marine vibrator sources, sparker sources, and boomer sources. Vessel 702 is also shown towing one or more streamers 104 in body of water 106. During the survey, controlled seismic source(s) 108 are activated. Reflections associated with the controlled source activations are received at sensors 110 and are recorded by the control equipment aboard vessel 702. Simultaneously, one or more uncontrolled acoustic sources are present in the body of water. In the survey illustrated, vessel 702 itself or machinery onboard the vessel produces uncontrolled acoustic energy 703. In other embodiments, other uncontrolled acoustic sources may be present. Reflections associated with the uncontrolled acoustic source(s) are also received at sensors 110 and are recorded in a blended fashion along with the reflections associated with the controlled source activations.

Solid line 707 illustrates an example ray path of uncontrolled acoustic energy that is emitted by vessel 702 and reflects toward a sensor in the streamer from a midpoint 705. Dashed line 709 illustrates an example ray path of acoustic energy that is emitted by controlled source 108 and reflects toward another sensor in the streamer from the same midpoint 705. Notably, the inline offset associated with ray path 707 is longer than is the inline offset associated with ray path 709. Thus, by utilizing the uncontrolled acoustic energy emitted by the towing vessel in addition to the controlled acoustic energy emitted by towed controlled sources, reflections from any common midpoint 705 in subsurface 712 can be recorded at longer offsets than would be achievable using a towed controlled source alone.

In addition, the uncontrolled acoustic energy emitted by a vessel 702 typically contains much more energy at low frequencies relative to the energy that is emitted by some controlled sources such as sparkers and boomers.

In light of the above, it can be seen that, by collecting and recording acoustic energy from both controlled seismic sources and uncontrolled acoustic sources during the same marine seismic survey, additional information about the subsurface (e.g., information at longer offsets and/or information at lower frequencies) may be acquired relative to the information that can be acquired by using controlled seismic sources alone.

Moreover, by using techniques to be described herein to isolate controlled source energy and uncontrolled source energy from the recorded seismic data, images that are generated based on the controlled source energy may be improved. This is so because the uncontrolled source energy would appear as noise in the images that are generated based on the controlled source energy if the uncontrolled source energy were not isolated and separated from the controlled source energy prior to generating the images.

In various embodiments, some or all of the uncontrolled acoustic energy utilized to gain additional information about the subsurface may be emitted by an uncontrolled source other than tow vessel 702. For example, in survey 700, an additional vessel 703 is shown emitting uncontrolled acoustic energy 711 in the body of water, which energy produces reflections such as reflection 708 that are also recorded by the sensors in the streamers. In the illustrated example, vessel 703 is shown sailing on top of streamer spread 104 at an inline position behind the head end of the streamers and ahead of the tail end of the streamers. In other embodiments, other positions may be used for vessel 703, including positions at a crossline offset from a streamer or from the streamer spread, and including inline positions ahead of or behind the streamer spread. Uncontrolled acoustic energy from either or both of vessels 702 and 703 may be collected and utilized to gain information about subsurface 712.

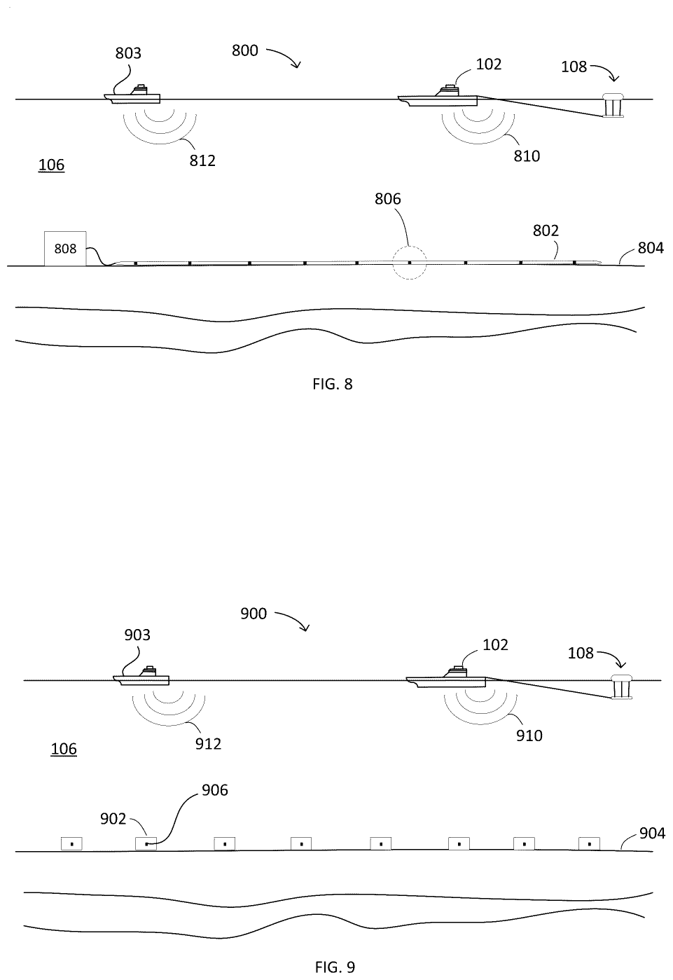

Techniques in accordance with embodiments may also be used in conjunction with marine seismic surveys that utilize ocean bottom cables and/or nodes, either separately or in combination with towed streamers. Accordingly, FIG. 8 is a side view illustrating an example ocean bottom cable survey in accordance with embodiments, and FIG. 9 is a side view illustrating an example ocean bottom node survey in accordance with embodiments.

Referring now to FIG. 8, an ocean bottom cable survey system 800 is shown in which a vessel 102 tows one or more controlled sources 108 over an installation of one or more ocean bottom cables 802, each of which is disposed on a water bottom 804. Each cable 802 may include one or more sensors or sensor groups 806 disposed along its length, generally as shown. In turn, each of the cables may be coupled to a manifold 808 in which signals from the sensors may be aggregated and either stored or transmitted to a collection point, or both. As in the example of FIG. 7, uncontrolled acoustic energy 810 is emitted by vessel 102 during the ocean bottom cable survey, producing associated reflections that are received by sensors 806 along with reflections associated with activations of controlled seismic source 108. Also as in the example of FIG. 7, other uncontrolled acoustic sources may be present during the survey and may be utilized in addition to or in lieu of energy 810. For instance, in the illustrated example, an additional vessel 803 may sail over the survey area. Vessels 803 emits uncontrolled acoustic energy 812, which also produces reflections that are received by sensors 806 along with reflections associated with controlled seismic source 108 and reflections associated with uncontrolled acoustic energy 810.

Referring now to FIG. 9, an ocean bottom node survey 900 is shown in which a vessel 102 tows one or more controlled sources 108 over an installation of one or more ocean bottom nodes 902, each of which may be disposed on a water bottom 904. Each node 902 may include one or more sensors or sensor groups 906 as shown. Signals generated by the sensors or sensor groups may be collected in the nodes for later retrieval, or may be transmitted to a collection point, or both. As in the examples of FIG. 7 and FIG. 8, uncontrolled acoustic energy 910 is emitted by vessel 102 during the ocean bottom node survey, producing associated reflections that are received by sensors 906 along with reflections associated with activations of controlled seismic source 108. Also as in the examples of FIG. 7 and FIG. 8, other uncontrolled acoustic sources may be present during the survey and may be utilized in addition to or in lieu of energy 910. For instance, in the illustrated example, an additional vessel 903 may sail over the survey area. Vessels 903 emits uncontrolled acoustic energy 912, which also produces reflections that are received by sensors 906 along with reflections associated with controlled seismic source 108 and reflections associated with uncontrolled acoustic energy 910.

Techniques to be described herein may be employed in the context of any of the above or similar types of marine seismic surveys.

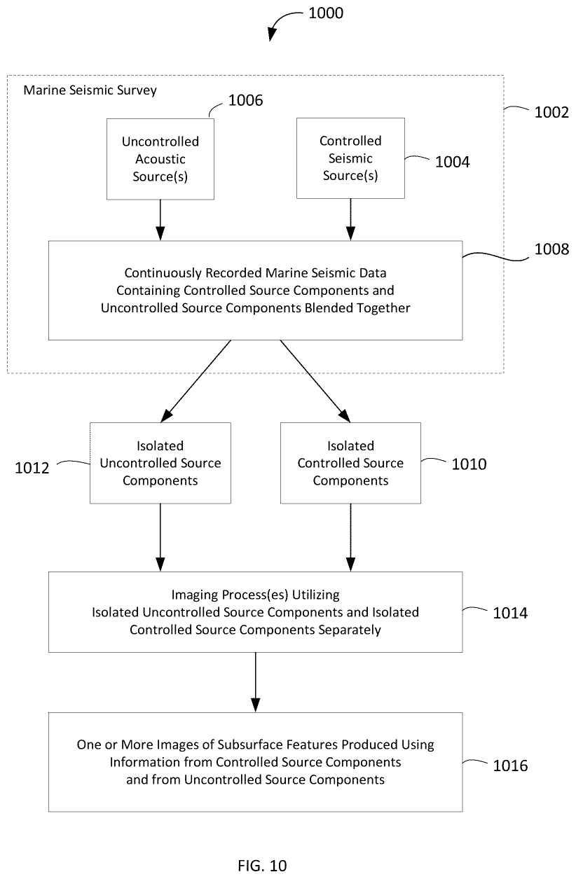

FIG. 10 illustrates a process 1000 in accordance with embodiments in which one or more images of subsurface geological features may be generated based on recorded seismic data acquired from sensors used during a marine seismic survey 1002. During the survey, a tow vessel tows one or more controlled seismic sources 1004 in a body of water while one or more uncontrolled acoustic sources 1006 are also present in the body of water. Signals detected by the sensors are continuously recorded as the survey proceeds, resulting in a set of continuously recorded marine seismic data 1008. The continuously recorded marine seismic data contain controlled source components (i.e., signals associated with the controlled seismic sources) and uncontrolled source components (i.e., signals associated with the uncontrolled acoustic sources) blended together. The uncontrolled source components in the continuously recorded data may contain one or more attributes that the controlled source components do not contain. For example, the uncontrolled source components may contain signal content at lower frequencies than the signal content present in the controlled source components, or the uncontrolled source components may contain signal content at longer offsets than the signal content present in the controlled source components, or both.

Either during the survey or, more typically, after the survey has been completed, a separation procedure is applied to isolate the controlled source components 1010 from the continuously recorded data and to isolate the uncontrolled source components 1012 from the continuously recorded data. The isolated controlled source components correspond to acoustic energy emitted by activations of the one or more controlled seismic sources during the survey. The isolated uncontrolled source components correspond to acoustic energy emitted by the one or more uncontrolled acoustic sources (such as by the tow vessel itself and/or its propulsion system) that were present during the survey.

After the separation procedure has been performed, one or more imaging processes 1014 utilize the isolated controlled source components and the isolated uncontrolled source components to appropriately use information contained in each. The imaging process(es) may result in one or more images 1016 of subsurface features that are improved relative to images that might have been produced by using the controlled source components alone, due to the added information contributed by the unique features of the uncontrolled source components (e.g., lower frequency signal content and/or signal content at longer offsets). The imaging process(es) may also result in additional images of subsurface features that would not have been possible to generate using the controlled source components alone, due to the added information contributed by the uncontrolled source components.

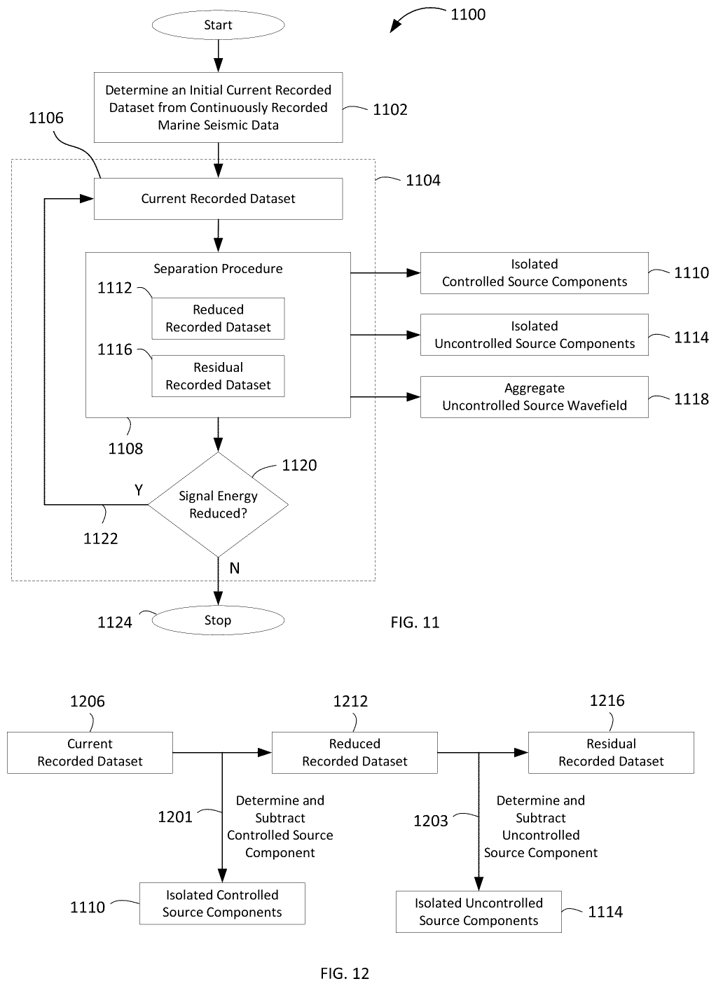

FIG. 11 is a flow diagram illustrating an example computer-implemented method 1100 for extracting isolated controlled source components and isolated uncontrolled source components from a recorded dataset in accordance with embodiments. In some embodiments, the method may be iterative, such that each iteration modifies a current recorded dataset by extracting a portion of the isolated controlled source components and a portion of the isolated uncontrolled source components from the current recorded dataset during the iteration. After each iteration, a test may be performed to determine if the components so extracted have reduced the signal energy in the current recorded dataset by at least a threshold amount. If so, then another iteration is performed, but if not, then the separation procedure stops.

A benefit of performing method 1100 iteratively is that removing an uncontrolled source component prior to beginning a next iteration improves the signal to noise ratio of the remaining controlled source components in the recorded dataset for the next iteration. Likewise, removing a controlled source component during a current iteration improves the signal to noise ratio of the remaining uncontrolled source components in the recorded dataset for the remainder of the current iteration. The improved signal to noise ratios, in turn, improve accuracy when determining the respective next components to be extracted from the recorded dataset.

Referring now to FIG. 11, at step 1102, continuously recorded marine seismic data from a survey are accessed, and a subset of the data is selected to serve as the initial current recorded dataset for a first iteration of the separation procedure. The initial current recorded dataset may comprise, for example, data from one sail line of the survey. Other subset sizes may also be used.

The dashed line in the drawing indicates the steps that are performed during a single iteration 1104 of the method. At step 1106 of the first iteration, the initial current recorded dataset that was selected in step 1102 is taken as the current recorded dataset to be modified during the iteration. Separation procedure 1108 is then performed on the current recorded dataset. The separation procedure determines a controlled source component in the current recorded dataset, subtracts the controlled source component from the current recorded dataset, and adds the controlled source component to an accumulating set of isolated controlled source components 1110. (Prior to the first iteration, the accumulating set of isolated controlled source components 1110 is initially empty.) The act of subtracting the controlled source component from the current recorded dataset produces a reduced recorded dataset 1112. The reduced recorded dataset corresponds to the contents of the current recorded dataset after the controlled source component has been removed therefrom.

The separation procedure then determines an uncontrolled source component in the reduced recorded dataset, subtracts the uncontrolled source component from the reduced recorded dataset, and adds the uncontrolled source component to an accumulating set of isolated uncontrolled source components 1114. (Prior to the first iteration, the accumulating set of isolated uncontrolled source components is initially empty.) The act of subtracting the uncontrolled source component from the reduced recorded dataset produces a residual recorded dataset 1116. The residual recorded dataset corresponds to the contents of the reduced recorded dataset after the uncontrolled source component has been removed therefrom.

In some embodiments, method 1100 may also accumulate an aggregate uncontrolled source wavefield 1118 as it accumulates the isolated uncontrolled source components. In such embodiments, each iteration of separation procedure 1108 determines an uncontrolled source wavefield component in the course of determining the uncontrolled source component of the reduced recorded dataset, and adds the uncontrolled source wavefield component to an accumulating aggregate uncontrolled source wavefield 1118. (Prior to the first iteration, the accumulating aggregate uncontrolled source wavefield is initially empty.)

At step 1120, the method determines whether extracting the controlled source component and the uncontrolled source component from the current recorded dataset has reduced signal energy in the current recorded dataset by at least a threshold amount. If it is determined that signal energy has been reduced by at least the threshold amount, then this indicates that additional reductions might be achieved by a further iteration of procedure 1108. If so, then the current recorded dataset is replaced with the residual recorded dataset, and another iteration of the procedure is performed using the (now modified) current recorded dataset, as indicated at arrow 1122. On the other hand, if it is determined that signal energy has not been reduced by at least the threshold amount, then this indicates that a point of diminishing returns has been reached such that further iterations of procedure 1108 will not likely produce significant reductions in signal energy. In the latter case, the method may be stopped, as indicated at 1124.

Any of several methods may be used to perform step 1120. In some embodiments, a level of signal energy in the residual recorded dataset may be compared with a level of signal energy that was present in the current recorded dataset at the beginning of the iteration (or equivalently, in the residual recorded dataset from the prior iteration). In other embodiments, a level of signal energy in the residual recorded dataset may be compared with signal energy in the reduced recorded dataset for the iteration. In still other embodiments, a level of signal energy in the residual recorded dataset may be compared with signal energy in the current recorded dataset and with signal energy in the reduced recorded dataset. In any embodiments, a suitable measure of the level of signal energy in a dataset may comprise a root-mean-square amplitude (“RMS”) of the signals in the dataset. Other measures may also be used. Moreover, any threshold may be chosen to determine the outcome of the comparison, depending on the needs of the application. By way of non-limiting example, in some embodiments, a threshold of 1% may be used, such that a reduction in signal energy of at least 1% relative to the prior iteration will result in an additional iteration being performed, otherwise not. Other thresholds may also be used, as appropriate to the application.

After method 1100 has been performed for all subsets of the data that were acquired during the marine seismic survey, or for a desired portion thereof, one or more images of subsurface features may be generated based on the isolated controlled source components 1110 and on the isolated uncontrolled source components 1114 from the processed subsets of acquired data, as will be further discussed below.

FIG. 12 is a flow diagram illustrating a single iteration of separation procedure 1108. Beginning with a current recorded dataset 1206, a controlled source component of the current recorded dataset is determined and is subtracted from the current recorded dataset to produce a reduced recorded dataset 1212. The controlled source component is added to an accumulating set of isolated controlled source components 1110, as indicated at arrow 1201. An uncontrolled source component of reduced recorded dataset 1212 is determined and is subtracted from the reduced recorded dataset to produce a residual recorded dataset 1216. The uncontrolled source component is added to an accumulating set of isolated uncontrolled source components 1114, as indicated at arrow 1203.

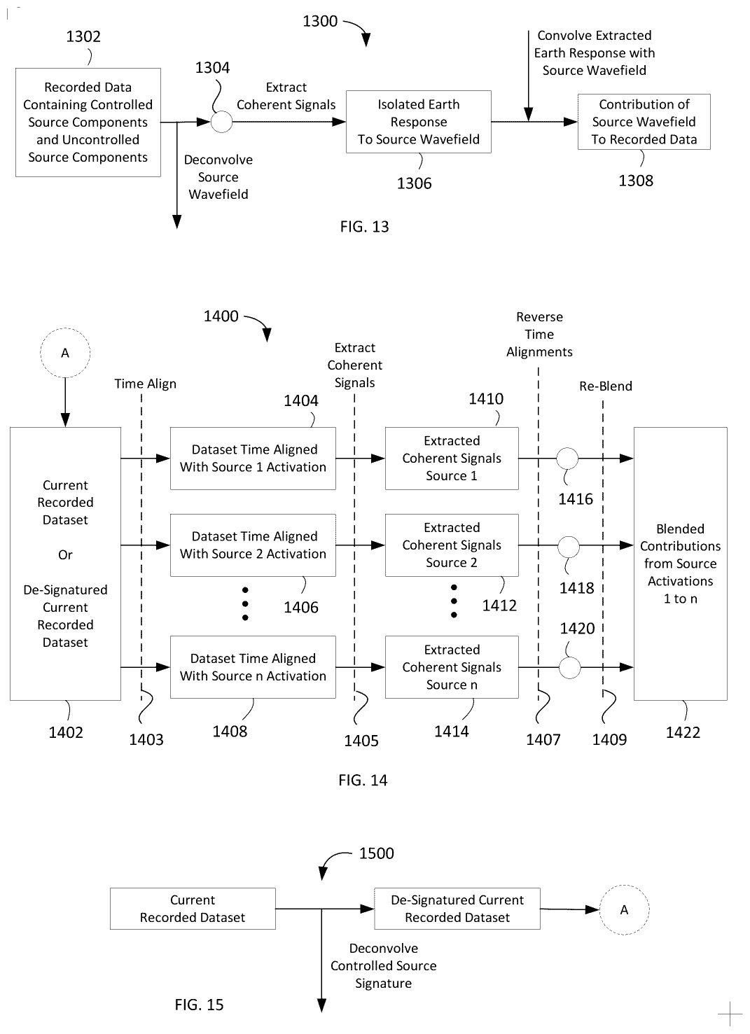

Example methods for determining the controlled source component and the uncontrolled source component in a given iteration of separation procedure 1108 will now be described with reference to FIGS. 13-16.

### General Procedure for Determining Source Contributions

FIG. 13 is a flow diagram schematically illustrating a procedure that may be used to determine the contribution of a given source wavefield to a set of recorded seismic data. In general, procedure 1300 can be used to identify contributions from a source wavefield in a recorded dataset regardless of the type of source that produced the wavefield. As will be discussed further below, however, for certain types of sources (e.g., for impulsive sources), methods that are less computationally intensive than procedure 1300 may be used to identify the contributions of the sources in a recorded dataset.

Procedure 1300 is based on the knowledge that the reflection wavefield that reaches a seismic sensor or sensor group in a marine seismic survey represents the convolution of the source wavefields that produced the reflection wavefield and the earth response to those source wavefields:

r=(s*g)+n,

where r represents the reflection wavefield, s represents the contributing source wavefield, g represents the earth response to the contributing source wavefield, * represents convolution, and n represents noise or any acoustic signals that are not related to the source generating s (and that have not been separated from s). Acoustic signals represented by n will appear to be incoherent when deconvolving s from r, and therefore only the coherent signals after deconvolution will be selected during the separation process, as will be further discussed below.

Procedure 1300 begins with a recorded dataset 1302 that contains contributions from one or more controlled sources (controlled source components) and also contributions from one or more uncontrolled sources (uncontrolled source components). To determine the contributions in dataset 1302 that are attributable to a given source wavefield—whether emitted by a controlled source or by an uncontrolled source—the given source wavefield may be deconvolved from dataset 1302 to produce an intermediate earth response 1304. To better isolate just the desired earth response from the given wavefield, a coherency filtration procedure may be performed (according to known techniques) on the intermediate earth response, and coherent signals may be extracted from the intermediate earth response to generate an isolated earth response 1306 to the given source wavefield. Finally, the given source wavefield may be convolved with the isolated earth response to produce the contribution 1308 of the given source wavefield to the recorded dataset 1302.

Determining Contributions from Controlled Sources

In general, procedure 1300 may be used to determine the contributions in a recorded dataset from any controlled seismic source, including from non-impulsive sources such as marine vibrators. As was mentioned above, however, for certain types of sources, it is possible to determine the contribution of the sources to a recorded dataset by methods that are less computationally intensive than procedure 1300. Accordingly, FIG. 14 is a flow diagram schematically illustrating an example procedure 1400 that may be used to determine the contribution of one or more impulsive source activations to a recorded dataset.

Referring now to FIG. 14, procedure 1400 begins with a current recorded dataset 1402, which may contain contributions from one or more impulsive seismic sources as well as contributions from other controlled or uncontrolled acoustic sources. A set of traces in the recorded dataset are time aligned with a given impulsive source activation (step 1403). Coherent signals are then extracted from the resulting set of time aligned traces (step 1405). At step 1407, the time alignment is reversed in the set of time aligned traces, which results in a set of traces (for example, set 1416) that represent the contribution of the given source activation to the recorded dataset 1402. Steps 1403, 1405, and 1407 may be performed using any of several techniques known to persons having skill in the art.

For surveys in which multiple impulsive seismic sources were in use and in which the sources were activated closely in time with one another, then it is possible that contributions from more than one source activation will be present in the recorded dataset in a blended fashion. In such a case, method 1400 contemplates identifying the contributions from each of n impulsive source activations independently and then re-blending (step 1409) the identified contributions to produce a dataset 1422 that represents the blended contributions of the n sources to the recorded dataset 1402. For example, traces in recorded dataset 1402 may be time aligned with an activation of source 1, producing a dataset 1404 of traces that are time aligned with source 1. In like fashion, the traces in recorded dataset 1402 may be time aligned with an activation of source 2, producing a dataset 1406 of traces that are time aligned with source 2, and the traces in dataset 1402 may again be time aligned with an activation of source n, producing a dataset 1408 of traces that are time aligned with source n. Coherent signals may then be extracted from each of the time aligned datasets independently, producing respective sets of extracted coherent signals for each of sources 1 to n (see 1410, 1412, and 1414). The time alignments are then reversed in each of the coherent signal datasets, producing sets of traces 1416, 1418, 1420 that represent the respective contributions from each of sources 1 to n to the recorded dataset 1402. The contribution datasets 1416, 1418, 1420 are then re-blended (for example, by summing the datasets), which results in a dataset 1422 that represents the blended contributions from each of sources 1 to n. Finally, in step 1201, the blended contributions 1422 may be subtracted from the current recorded dataset 1206 of a given iteration of separation procedure 1108 to produce the reduced recorded dataset 1212 for that iteration.

Impulsive sources vary in the quality of the impulses they produce. Boomer sources, for example, tend to produce an impulse with reverberations. The reverberations in the wavefield represent the “signature” of the boomer source and are due to damped oscillations of the boomer diaphragm that occur after each activation of the boomer. (The signature of any controlled seismic source can be determined using known techniques, such as by making use of near-field recordings of corresponding source activations.) Therefore, in some embodiments, and for a given controlled source, it may be beneficial to de-signature the recorded seismic data prior to identifying the contributions of the given source to the recorded data.

Accordingly, for any such impulsive sources that may benefit from such a de-signature operation, a procedure 1500 (illustrated in FIG. 15) may be performed on the current recorded dataset of an iteration prior to performing method 1400 on the dataset. Referring now to FIG. 15, the signature of a controlled source, such as a boomer, may be deconvolved from a current recorded dataset 1502 during a given iteration of separation procedure 1108 to produce a de-signatured current recorded dataset 1504. Doing so causes the effects of the source signature to be removed from the recorded dataset so that the de-signatured dataset represents reflections associated with a sharper, more well-defined impulsive source wavefield. Then, as indicated at “A” in both of FIGS. 14 and 15, method 1400 may be performed on the de-signatured dataset instead of on the original recorded dataset to better identify the contributions of the impulsive source activations. If more than one impulsive controlled source was in use during the survey—each with a different source signature for its respective activations—then the de-signature procedure 1500 may be applied to the current recorded dataset separately for each of the sources 1 to n, thereby producing n de-signatured datasets. Steps 1403, 1405, and 1407 may then be applied to each of the n de-signatured datasets independently.

For embodiments in which de-signature procedure 1500 is employed, the de-signature process may be reversed (such as, for example, prior to performing re-blending step 1409) before re-blended contributions 1422 are subtracted from the current recorded dataset for a given iteration. By way of example, the de-signature process of FIG. 15 may be reversed for a given source by re-convolving the signature of the corresponding source with the isolated contributions (1416, 1418, or 1420) associated with that source.

In some embodiments, de-signature procedure 1500 may be employed for boomer-type controlled sources but not for sparker-type controlled sources. In other embodiments, de-signature procedure 1500 may be employed for all controlled source types. In still other embodiments, de-signature procedure 1500 may be omitted.

Determining Contributions from Uncontrolled Sources

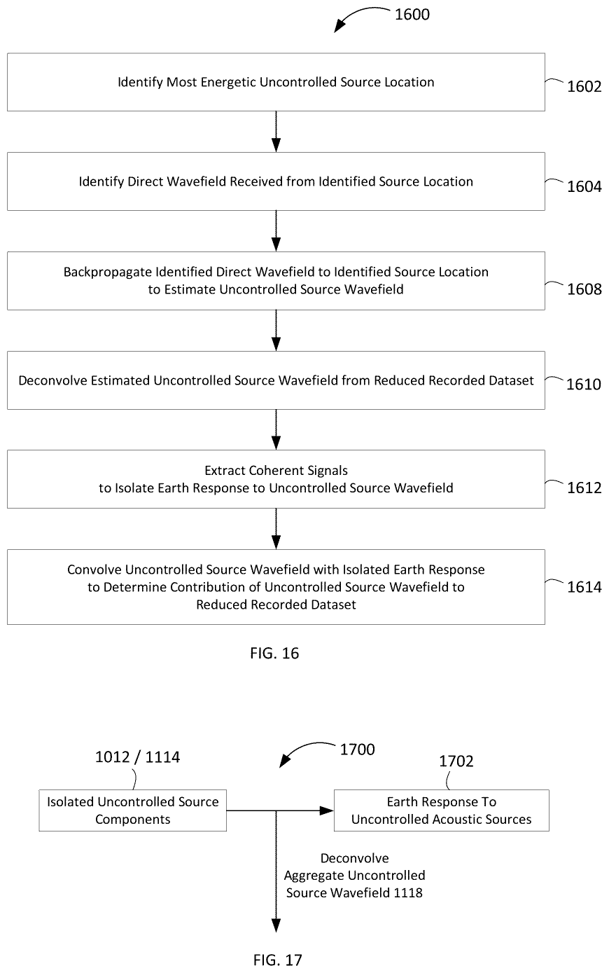

FIG. 16 is a flow diagram illustrating an example uncontrolled source identification procedure 1600 that may be used to determine the contributions of an uncontrolled acoustic source, such as a marine vessel, to a recorded dataset. In particular, procedure 1600 may be used during each iteration of separation procedure 1108 to determine an uncontrolled source component in a current recorded dataset 1106, 1206 or in a reduced recorded dataset 1112, 1212.

If desired, any or all of the steps in procedure 1600 may be performed in accordance with techniques further described in US Patent Application Publication 20220365237 by Hegna, titled “Using Ambient Acoustic Energy as a Passive Source in Marine Seismic Surveys,” the contents of which are hereby incorporated as if entirely set forth herein. By way of further background, using acquired seismic data to estimate the acoustic signals generated by a vessel without actively controlled seismic sources can be accomplished according to techniques described in one or more of the following additional references, the contents of all of which are hereby incorporated as if entirely set forth herein: Hegna, “Continuous Wavefields Method—The Acoustic Wavefield Generated by the Seismic Vessel,” 82^{nd} EAGE Annual Conference & Exhibition, Vol. 2021, pp. 1-5 (EAGE, October 2021); Hegna, et al., “The Acoustic Wavefield Generated by a Vessel Sailing Over Ocean Bottom Cables,” 84^{th} Annual EAGE Annual Conference & Exhibition (EAGE, Jun. 5, 2023); Hegna, “Estimation of the Acoustic Wavefield Generated by a Seismic Vessel from Towed-Streamer Data,” First International Meeting for Applied Geoscience & Energy, Technical Program Expanded Abstracts, pp. 2011-2015 (SEG, 2021); Hegna, “Imaging the Subsurface Using Acoustic Signals Generated by a Vessel,” First Break, Vol. 40, Issue 11, pp. 47-53 (EAGE, Nov. 1, 2022); and Hegna, “The Acoustic Wavefield Generated by a Vessel Sailing on Top of a Streamer Spread,” 83^{rd} EAGE Annual Conference & Exhibition, Vol. 2022, pp. 1-5 (EAGE, June 2022).

Referring now to FIG. 16, at step 1602, procedure 1600 begins by identifying a most energetic uncontrolled source location—for example by using signal intensities associated with direct wavefields arriving at sensors in an array of seismic sensors (e.g., the sensors in a set of streamers or those in ocean bottom cables or nodes). Once a most energetic location has been identified, it is possible to characterize the direct wavefield as received by the sensors from the identified location (step 1604). The direct wavefield may then be backpropagated to the identified location to estimate the uncontrolled source wavefield as emitted at the source location (step 1608).

Once the uncontrolled source wavefield has been estimated, procedure 1300 may be applied to determine the contribution of the uncontrolled source wavefield to a recorded dataset. Thus, at step 1610, procedure 1600 deconvolves the estimated uncontrolled source wavefield from the reduced recorded dataset for a given iteration of separation procedure 1108, producing an intermediate earth response dataset. At step 1612, procedure 1600 extracts coherent signals from the intermediate earth response dataset to produce an isolated earth response dataset, which represents the earth response to the uncontrolled acoustic wavefield identified in step 1602. Finally, in step 1614, the procedure convolves the estimated uncontrolled source wavefield with the isolated earth response to determine the contribution of the uncontrolled source wavefield to the reduced recorded dataset.

In some embodiments, uncontrolled source identification procedure 1600 may be performed once per iteration of separation procedure 1108. In other embodiments, uncontrolled source identification procedure 1600 may be performed more than once in a given iteration of the separation procedure.

Each time uncontrolled source identification procedure 1600 is performed, an uncontrolled source wavefield is estimated during step 1608 of the procedure. Thus, in some embodiments, the uncontrolled source wavefield so estimated may be added to an accumulating (and initially empty) aggregate uncontrolled source wavefield 1118 as the separation procedure advances. The aggregate uncontrolled source wavefield so accumulated may be used in connection with generating one or more images of the subsurface, as will be further described below.

### Image Generation Using Controlled and Uncontrolled Source Components

As was described above in relation to method 1000, one or more images of subsurface features may be generated using isolated uncontrolled source components 1012 and isolated controlled source components 1010 separately. Once these components have been identified and isolated in accordance with the techniques described above, known imaging techniques may be applied to the components to generate one or more images of subsurface features. In some embodiments, the isolated controlled source components may be applied as inputs to a first imaging process to generate a first image of subsurface features, and the isolated uncontrolled source components may be applied as inputs to a second imaging process to generate a second image of subsurface features. For example, in such embodiments, the second image may illustrate subsurface features disposed at greater depths than subsurface features that are illustrated in the first image. In other embodiments, the isolated controlled source components and the isolated uncontrolled source components may be applied as inputs to generate a single image. In the latter embodiments, the image may be generated using attributes that are unique to the respective types of source components such that the image quality is improved relative to an image that might have been generated using only the controlled source components alone.

An intermediate step employed by such imaging techniques is to identify an earth response to the various sources that were used during the subject survey. Accordingly, FIG. 17 is a flow diagram illustrating a procedure 1700 that may be used to determine an earth response associated with uncontrolled acoustic sources, such as one or more marine vessels, that were present during the survey. Specifically, aggregate uncontrolled source wavefield 1118 may be deconvolved from the isolated uncontrolled source components 1012, 1114, as indicated by arrow 1702. The result of the deconvolution is an earth response to the uncontrolled acoustic sources 1702 (i.e., an earth response to the isolated uncontrolled source components). As was described above, such an earth response may be used during imaging to provide information about the subsurface that is not possible to provide by using the controlled sources alone.

An analogous procedure may be used, if desired, to determine an earth response to the isolated controlled source components.

### Example Applications

The techniques described above for using signal energy from both controlled and uncontrolled sources during the same seismic survey may be employed in any of the survey types described in relation to FIGS. 1-9, or in any combinations of those, as well as in other survey types. The controlled sources used in such surveys may comprise any variety of controlled seismic sources, including without limitation air gun sources, marine vibrator source, sparkers, and boomers, or may comprise any combinations of controlled source types. The uncontrolled sources used may comprise any of those described above or others, including without limitation marine vessels or parts thereof.

The techniques described above also have utility in high-resolution site surveys in which a survey vessel (i.e., a tow vessel) tows one or more controlled sources and also a spread of streamers having lengths of about 200 meters or less in relatively shallow water, and in which the controlled sources comprise sparkers, boomers, or small air guns. In such surveys, the uncontrolled sources may comprise at least a portion of the tow vessel (such as, for example, the vessel's propellers) and/or machinery aboard the tow vessel. Because of the relatively short lengths of the streamers used in such surveys, the longer offsets provided by the uncontrolled acoustic energy from the tow vessel are particularly beneficial for improving the quality of the images of the subsurface, or for producing separate images of subsurface features disposed at greater depths than those that are imaged by the controlled sources. Moreover, because of the lack of low frequency energy emitted by the types of controlled sources that are typically used for high-resolution imaging of the shallow parts of the subsurface, the low frequency content present in the uncontrolled source energy may be used to generate images of subsurface features disposed at greater depths than those that are imaged by the controlled sources.

### Example Computer System

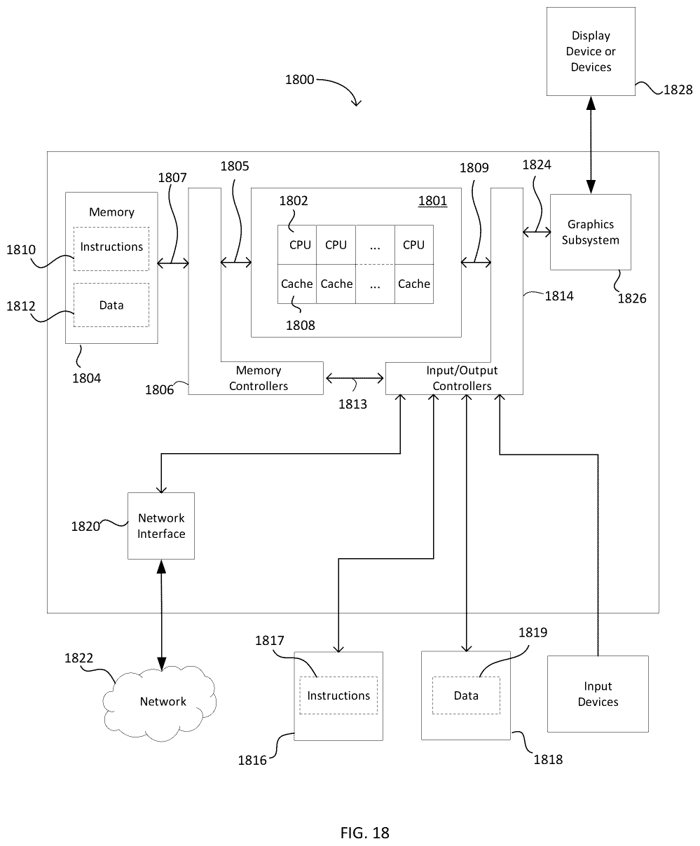

FIG. 18 is a block diagram logically illustrating an example computer system 1800 that may be used in conjunction with embodiments and/or to perform any of the methods described herein. Persons having skill in the art and having reference to this disclosure will appreciate that suitable computer system architectures may vary and that alternative or additional types of computing devices may also be employed in conjunction with any of the embodiments described herein. Computer system 1800 is therefore shown by way of example and not by way of limitation.

Computer system 1800 includes a core/cache complex 1801 that contains one or more central processor unit (“CPU”) cores 1802, each of which is associated with one or more levels of high-speed cache memory 1808. The core/cache complex is in turn coupled to one or more high-speed memory controllers 1806, as indicated at 1805, and to one or more input/output controllers 1814, as indicated at 1809. The memory controllers and the input/output controllers may additionally be coupled to one another via one or more high-speed interconnects 1813.

The memory controllers may be coupled to a system memory 1804 by any suitable means, such as via a high-speed memory bus 1807. The memory controllers facilitate interactions between the system memory and the core/cache complex as well as between the system memory and the input/output controllers. System memory 1804 typically comprises a large array of random-access memory locations, often housed in multiple dynamic random-access memory (“DRAM”) devices, which in turn may be housed in one or more dual inline memory module (“DIMM”) packages, as shown. Each core 1802 can execute computer-readable instructions 1810 stored in the system memory, and can thereby perform operations on data 1812, also stored in the system memory.

The input/output controllers may be coupled to respective subsystems as indicated in the drawing. Non-limiting examples of such subsystems include a graphics subsystem 1826, a network interface 1820, one or more non-transitory computer-readable media such as computer-readable medium 1816 and computer-readable medium 1818.

Network interface 1820 may facilitate interactions between components of the computer system and an external network 1822. Non-limiting examples of network 1822 include a local area network, a wide area network, the internet, or any combination of these.

Non-limiting examples of non-transitory computer-readable media include so-called solid-state disks (“SSDs”), spinning-media magnetic disks, optical disks, flash drives, magnetic tape, and the like. The storage media may be permanently attached to the computer system or may be removable and portable. In the example shown, medium 1816 has instructions 1817 (software) stored therein, while medium 1818 has data 1819 stored therein. Operating system software executing on the computer system may be employed to enable a variety of functions, including transfer of instructions 1810, 1817 and data 1812, 1819 back and forth between the storage media and the system memory.

In embodiments that include a graphics subsystem, one or more of the input/output controllers may be coupled to the graphics subsystem by any suitable means, such as by a high-speed bus 1824. The graphics subsystem may in turn be coupled to one or more display devices 1828. While display devices 1828 may be located in physical proximity to the rest of the components of the computer system, they may also be remotely located. Software running on the computer system may generate instructions or data that cause graphics subsystem to display any of the example user interface elements described above on display devices 1828. Such software may also generate instructions or data that cause the display of such elements on one or more remotely located display devices (for example, display devices attached to a remotely located computer system) by sending the instructions or data over network 1822 using an appropriate network protocol. The graphics subsystem may comprise one or more graphics processing units (“GPUs”) to accelerate the execution of instructions or to implement any of the methods described above.

Computer system 1800 may represent a single, stand-alone computer workstation that is coupled to input/output devices such as a keyboard, pointing device and display. It may also represent one of the nodes in a larger, multi-node or multi-computer system such as a cluster, in which case access to its computing capabilities may be provided by software that interacts with and/or controls the cluster. Nodes in such a cluster may be co-located in a single data center or may be distributed across multiple locations or data centers in distinct geographic regions. Furthermore, computer system 1800 may represent an access point from which such a cluster or multi-computer system may be accessed and/or controlled. Any of these or their components or variants may be referred to herein as “computing apparatus,” a “computing device,” or a “computer system.”

In example embodiments, data 1819 may correspond to sensor measurements or other data recorded during a marine geophysical survey or may correspond to a survey plan for implementing any of the surveys described herein. Instructions 1817 may correspond to instructions for performing any of the methods described herein. In such embodiments, instructions 1817, when executed by one or more computing devices such as one or more of CPU cores 1802, cause the computing device to perform operations described herein on the data, producing results that may be stored in one or more tangible, non-volatile, computer-readable media such as medium 1818. In such embodiments, medium 1818 constitutes a geophysical data product that is manufactured by using the computing device to perform methods described herein and by storing the results in the medium. Geophysical data product 1818 may be stored locally or may be transported to other locations where further processing and analysis of its contents may be performed. If desired, a computer system such as computer system 1800 may be employed to transmit the geophysical data product electronically to other locations via a network interface 1820 and a network 1822 (e.g., the Internet). Upon receipt of the transmission, another geophysical data product may be manufactured at the receiving location by storing contents of the transmission, or processed versions thereof, in another tangible, non-volatile, computer readable medium. Similarly, geophysical data product 1818 may be manufactured by using a local computer system 1800 to access one or more remotely-located computing devices in order to execute instructions 1817 remotely, and then to store results from the computations on a medium 1818 that is attached either to the local computer or to one of the remote computers. The word “medium” as used herein should be construed to include one or more of such media.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations than those described, and some components may be omitted, while other components may be added, except where the context clearly indicates otherwise. The scope of the disclosure is intended to include all such combinations, modifications, and generalizations as well as their equivalents.

What is claimed is:

1. A method of imaging a subsurface disposed beneath a water bottom, comprising:
determining a current recorded dataset from continuously recorded marine seismic data, wherein the current recorded dataset includes signals associated with one or more uncontrolled acoustic sources and also signals associated with one or more controlled seismic sources;
performing one or more iterations of a separation procedure on the current recorded dataset to accumulate isolated controlled source components and isolated uncontrolled source components therefrom, wherein the separation procedure comprises:
determining a controlled source component of the current recorded dataset and adding the controlled source component to the isolated controlled source components, wherein the controlled source component corresponds to signals in the current recorded dataset that are associated with at least one of the controlled seismic sources;
subtracting the controlled source component from the current recorded dataset to generate a reduced recorded dataset;
determining an uncontrolled source component of the reduced recorded dataset and adding the uncontrolled source component to the isolated uncontrolled source components, wherein the uncontrolled source component corresponds to signals in the reduced recorded dataset that are associated with at least one of the uncontrolled acoustic sources;
subtracting the uncontrolled source component from the reduced recorded dataset to generate a residual recorded dataset; and
determining if signal energy in the residual recorded dataset differs by at least a threshold amount from signal energy in at least one of the current recorded dataset and the reduced recorded dataset, and, if so, replacing the current recorded data set with the residual recorded dataset and performing another iteration of the separation procedure; and
applying the isolated controlled source components as an input to an imaging process, and applying the isolated uncontrolled source components as an input to the or another imaging process, to generate one or more images of the subsurface.

2. The method of claim 1, wherein:
determining the uncontrolled source component comprises performing an uncontrolled source identification procedure that comprises identifying a most energetic uncontrolled source location and estimating an uncontrolled source wavefield at the uncontrolled source location.

3. The method of claim 2, wherein:
the uncontrolled source identification procedure is performed once per iteration of the separation procedure.

4. The method of claim 1, wherein:
the separation procedure further comprises accumulating an aggregate uncontrolled source wavefield.

5. The method of claim 4, wherein:
generating the image further comprises deconvolving the aggregate uncontrolled source wavefield from the isolated uncontrolled source components to generate an earth response associated with the isolated uncontrolled source components.

6. The method of claim 1, wherein:
determining if the signal energy in the residual recorded dataset differs by at least a threshold amount from the signal energy in at least one of the current recorded dataset and the reduced recorded dataset is based on an RMS amplitude of the residual recorded dataset and an RMS amplitude of at least one of the current recorded dataset and the reduced recorded dataset.

7. The method of claim 1:
wherein determining the controlled source component from the current recorded dataset comprises time aligning traces with a first controlled source activation, time aligning the traces with a second controlled source activation, and extracting coherent signals from the time aligned traces to produce isolated first coherent signals and isolated second coherent signals, respectively; and
wherein subtracting the controlled source component from the current recorded dataset comprises re-blending the isolated first coherent signals and the isolated second coherent signals to produce re-blended coherent signals, and subtracting the re-blended coherent signals from the current recorded dataset.

8. The method of claim 1, wherein:
the controlled source components comprise signals generated by at least one of: a sparker source and a boomer source.

9. The method of claim 1, wherein:
the controlled source components comprise signals generated by a sparker source; and
determining the controlled source component comprises time aligning traces with an activation of the sparker source and applying a coherency filter to the time aligned traces.

10. The method of claim 1, wherein:
the controlled source components comprise signals generated by a boomer source; and
determining the controlled source component comprises applying a boomer source de-signature operation to at least a portion of the current recorded dataset.

11. The method of claim 10, wherein:
applying the boomer source de-signature operation comprises deconvolving a signature of the boomer source from the portion of the current recorded dataset.

12. The method of claim 1, wherein:
the controlled source components comprise signals generated by an air gun.

13. The method of claim 1, wherein:
the controlled source components comprise signals generated by a marine vibrator.

14. The method of claim 1, wherein:
the uncontrolled source components comprise signals generated by a first marine vessel.

15. The method of claim 14, wherein:
the continuously recorded seismic data comprise signals recorded by at least one streamer that was towed by the first marine vessel.

16. The method of claim 15, wherein:
the uncontrolled source components further comprise signals generated by a second marine vessel distinct from the first marine vessel.

17. The method of claim 16, wherein:
the signals generated by the second marine vessel comprise signals generated while the second marine vessel was sailing at an inline position behind a lead end of the at least one streamer and ahead of a tail end of the at least one streamer.

18. The method of claim 1, wherein:
the isolated uncontrolled source components include greater signal content at lower frequencies than do the isolated controlled source components.

19. The method of claim 1, wherein:
the isolated uncontrolled source components include signal content at longer offsets than do the isolated controlled source components.

20. The method of claim 1, wherein:
the continuously recorded seismic data comprise signals that were recorded from streamers not exceeding 200 meters in length;
the streamers were towed by a tow vessel;
at least one of the one or more controlled seismic sources was also towed by the tow vessel; and
at least one of the one or more uncontrolled acoustic sources comprised at least a portion of the tow vessel or machinery aboard the tow vessel.

21. In a technological process of the kind in which one or more images of subsurface geological features are generated based on recorded seismic data acquired by sensors while a vessel towed one or more controlled seismic sources in a body of water and while one or more uncontrolled acoustic sources were present in the body of water, the specific improvement comprising:
isolating controlled source components from the recorded seismic data, wherein the controlled source components correspond to acoustic energy emitted by activations of the one or more controlled seismic sources;
isolating uncontrolled source components from the recorded seismic data, wherein the uncontrolled source components correspond to acoustic energy emitted by the vessel, and wherein the uncontrolled source components include at least one of the following attributes: signal content present at lower frequencies than signal content present in the controlled source components, and signal content present at longer offsets than signal content present in the controlled source components; and
applying the isolated controlled source components as an input to an imaging process, and applying the isolated uncontrolled source components as an input to the or another imaging process, to generate one or more images of the subsurface, thereby utilizing, in at least one of the images, at least one attribute present in the uncontrolled source components that is not present in the controlled source components.

22. The process of claim 21, wherein:
each of the isolating steps is performed during each of one or more iterations of a separation procedure; and
each of the one or more iterations of the separation procedure modifies a current recorded dataset.

23. The process of claim 22:
wherein isolating the controlled source components comprises time aligning traces with a first controlled source activation, time aligning the traces with a second controlled source activation, and extracting coherent signals from the time aligned traces to produce isolated first coherent signals and isolated second coherent signals, respectively; and
further comprising re-blending the isolated first coherent signals and the isolated second coherent signals to produce re-blended coherent signals, and subtracting the re-blended coherent signals from the current recorded dataset.

24. The process of claim 22, wherein:
isolating the uncontrolled source components comprises performing an uncontrolled source identification procedure; and
the uncontrolled source identification procedure comprises identifying a most energetic uncontrolled source location and estimating an uncontrolled source wavefield at the uncontrolled source location.

25. The process of claim 24, wherein:
the uncontrolled source identification procedure is performed once per iteration of the separation procedure.

26. One or more non-transitory computer-readable media containing instructions that, when executed by one or more processors, cause the one or more processors to perform a method of imaging a subsurface disposed beneath a water bottom, wherein the method comprises:
accessing a current recorded dataset from continuously recorded marine seismic data, wherein the current recorded dataset includes signals associated with one or more uncontrolled acoustic sources and also signals associated with one or more controlled seismic sources;
performing one or more iterations of a separation procedure on the current recorded dataset to accumulate isolated controlled source components and isolated uncontrolled source components therefrom, wherein the separation procedure comprises:
determining a controlled source component of the current recorded dataset and adding the controlled source component to the isolated controlled source components, wherein the controlled source component corresponds to signals in the current recorded dataset that are associated with at least one of the controlled seismic sources;
subtracting the controlled source component from the current recorded dataset to generate a reduced recorded dataset;
determining an uncontrolled source component of the reduced recorded dataset and adding the uncontrolled source component to the isolated uncontrolled source components, wherein the uncontrolled source component corresponds to signals in the reduced recorded dataset that are associated with at least one of the uncontrolled acoustic sources;
subtracting the uncontrolled source component from the reduced recorded dataset to generate a residual recorded dataset; and
determining if signal energy in the residual recorded dataset differs by at least a threshold amount from signal energy in at least one of the current recorded dataset and the reduced recorded dataset, and, if so, replacing the current recorded data set with the residual recorded dataset and performing another iteration of the separation procedure; and
applying the isolated controlled source components as an input to an imaging process, and applying the isolated uncontrolled source components as an input to the or another imaging process, to generate one or more images of the subsurface.

27. The media of claim 26, wherein:
determining the uncontrolled source component comprises performing an uncontrolled source identification procedure that comprises identifying a most energetic uncontrolled source location and estimating an uncontrolled source wavefield at the uncontrolled source location.

28. The media of claim 27, wherein:
the uncontrolled source identification procedure is performed once per iteration of the separation procedure.

29. The media of claim 26, wherein:
the separation procedure further comprises accumulating an aggregate uncontrolled source wavefield.

30. The media of claim 29, wherein:
generating the image further comprises deconvolving the aggregate uncontrolled source wavefield from the isolated uncontrolled source components to generate an earth response associated with the isolated uncontrolled source components.

31. The media of claim 26, wherein:
determining if the signal energy in the residual recorded dataset differs by at least a threshold amount from the signal energy in at least one of the current recorded dataset and the reduced recorded dataset is based on an RMS amplitude of the residual recorded dataset and an RMS amplitude of at least one of the current recorded dataset and the reduced recorded dataset.

32. The media of claim 26:
wherein determining the controlled source component from the current recorded dataset comprises time aligning traces with a first controlled source activation, time aligning the traces with a second controlled source activation, and extracting coherent signals from the time aligned traces to produce isolated first coherent signals and isolated second coherent signals, respectively; and
wherein subtracting the controlled source component from the current recorded dataset comprises re-blending the isolated first coherent signals and the isolated second coherent signals to produce re-blended coherent signals, and subtracting the re-blended coherent signals from the current recorded dataset.
